(19) United States
(12) Patent Application Publication
(10) Pub. No.: US 2026/0300670 A1
(43) Pub. Date: Oct. 1, 2026

(54) SYSTEM AND METHOD FOR HIGH-VOLUME READING AND PROCESSING OF NFC TAGS

(71) Applicant: PACKAGING INNOVATION, S. DE R.L., Panamá (PA)

(72) Inventors: Pedro Balgañón Canela, Barcelona (ES); Carlos Mendoza, Mérida (MX)

(21) Appl. No.: 19/705,555

(22) Filed: Jun. 11, 2026

Related U.S. Application Data
(63) Continuation-in-part of application No. 19/054,085, filed on Feb. 14, 2025, now Pat. No. 12,705,452.
Application No. 19/054,085 is a continuation-in-part of application No. 18/627,254, filed on Apr. 4, 2024, now Pat. No. 12,493,768.
Application No. 18/627,254 is a continuation-in-part of application No. 17/857,683, filed on Jul. 5, 2022, now Pat. No. 12,361,251.
Application No. 17/857,683 is a continuation-in-part of application No. 17/350,606, filed on Jun. 17, 2021, now Pat. No. 12,321,799.
Application No. 17/350,606 is a continuation-in-part of application No. 17/182,308, filed on Feb. 23, 2021, now Pat. No. 11,694,051.
Application No. 17/182,308 is a continuation of application No. 17/088,687, filed on Nov. 4, 2020, now Pat. No. 10,929,738.
(60) Provisional application No. 63/018,577, filed on May 1, 2020.

(51) Int. Cl. G06K 19/07; A24F 15/08; B65D 85/12; G06Q 30/0226; H04W 4/38; H04W 4/80; H04W 12/50

(52) U.S. Cl. CPC G06K 19/0723; A24F 15/08; B65D 85/12; G06Q 30/0226; H04W 4/38; H04W 4/80; H04W 12/50

(57) ABSTRACT

A computer implemented method for processing near field communication (NFC) tags associated with packaged products is disclosed. A computing device receives a production request including product data and requested NFC processing operations and transmits the production request to middleware communicatively coupled to an NFC reader. A packaged product comprising a container having a container NFC tag and a plurality of items having respective item NFC tags is positioned adjacent the NFC reader. The NFC reader reads the container NFC tag and the item NFC tags during a reading operation. Identifiers associated with the NFC tags are transmitted to the computing device, which determines whether a quantity of item NFC tags corresponds to an expected quantity associated with the product data. The computing device associates the container NFC tag with one or more item NFC tags and performs one or more NFC processing operations including tag activation, deactivation, production information assignment, inventory association, shipment association, and defective tag replacement.

### CROSS-REFERENCE TO RELATED APPLICATIONS

This patent application is a continuation in part of, and claims priority to, patent application Ser. No. 19/054,085 filed Feb. 14, 2025, which is a continuation in part of, and claims priority to, patent application Ser. No. 18/627,254 filed Apr. 4, 2024, which is a continuation in part of, and claims priority to, patent application Ser. No. 17/857,683 filed Jul. 5, 2022, which is a continuation in part of, and claims priority to, patent application Ser. No. 17/350,606 filed Jun. 17, 2021, which is a continuation in part of, and claims priority to, patent application Ser. No. 17/182,308 filed Feb. 23, 2021, which is a continuation of, and claims priority to, patent application Ser. No. 17/088,687 filed Nov. 4, 2020, which claims priority to provisional patent application 63/018,577 filed May 1, 2020. The subject matter of patent application Ser. Nos. 19/054,085, 18/627,254, 17/857,683, 17/350,606, 17/182,308, 17/088,687 and 63/018,577 are hereby incorporated by reference in their entirety.

### STATEMENT REGARDING FEDERALLY SPONSORED RESEARCH OR DEVELOPMENT

### Not applicable.

### INCORPORATION BY REFERENCE OF MATERIAL SUBMITTED ON A COMPACT DISC

Not applicable.

### TECHNICAL FIELD

The claimed embodiments relate to the field of reading and processing radio-frequency enabled tags and more specifically to systems and methods for performing bulk or simultaneous reading, processing, authentication, and association of near field communication (NFC) tags and radio-frequency identification (RFID) tags associated with packaged products.

### BACKGROUND

Near field communication (NFC) tags are increasingly used in manufacturing, logistics, inventory control, authentication, and consumer product tracking applications. NFC tags may be embedded in products, packaging, labels, bands, containers, and other items to store identifiers and other data that can be accessed by compatible reader devices. In some industries, NFC tags are used to associate individual products with manufacturing information, production dates, inventory records, distribution records, and digital content.

Conventional NFC systems are generally designed for reading one tag at a time or a small number of tags located within a limited reading area. In many existing systems, a user must manually position a reader device near each tag to obtain data from the tag. This process can be slow and labor intensive when large numbers of tagged products must be processed within a manufacturing or warehouse environment. As product volumes increase, manual reading operations may create delays and increase operational costs.

In some applications, products are packaged in boxes, cases, trays, or other groupings that contain multiple tagged items. Existing NFC readers may have difficulty reliably reading all tags within a packaged product arrangement. Signal interference, tag orientation, tag spacing, packaging materials, and overlapping read zones may reduce reading accuracy. In certain situations, some tags may not be detected while other tags may be read multiple times during the same operation.

Existing NFC systems also may lack mechanisms for reliably associating groups of tags with corresponding products, containers, or packaging units. In some environments, it may be desirable to associate a first tag corresponding to a container with additional tags corresponding to products located within the container. Conventional systems may require manual data entry or separate scanning operations to establish these relationships, which may increase the likelihood of errors.

Many existing NFC processing systems further rely on disconnected workflows between reader hardware, middleware software, production management systems, and inventory platforms. Data collected by NFC readers may require manual transfer, file conversion, or separate processing steps before the data can be used by external software systems. These disconnected workflows may reduce efficiency and may increase the likelihood of incomplete records or synchronization issues.

Conventional systems also may provide limited support for managing lifecycle operations associated with NFC tags. For example, some systems may not adequately support activation, deactivation, reassignment, replacement, or updating of NFC tags during manufacturing, packaging, quality control, returns processing, or inventory operations. In certain industries, defective tags or damaged products may require reassignment or replacement procedures that are difficult to perform using existing systems.

Automated processing environments present additional challenges. Conveyor systems and automated transport systems may move products through reading areas at varying speeds and orientations. Existing NFC reader configurations may not provide reliable coverage for products moving through automated environments, particularly where multiple tags are present within a single product grouping. In some cases, reading performance may depend heavily on operator positioning, product arrangement, or repeated scan attempts.

In addition, many conventional systems do not provide efficient mechanisms for associating NFC tag information with other identifiers, such as barcode identifiers, serial numbers, security codes, or production records. As a result, product tracking and authentication records may remain fragmented across multiple systems.

Therefore, there exists a need for improved systems and methods relating to the reading, processing, management, and association of NFC tags in manufacturing, packaging, inventory, authentication, and product tracking environments.

### SUMMARY

A computer-implemented method for processing near field communication (NFC) tags associated with packaged products is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claim subject matter's scope.

In one embodiment, the computer implemented method for processing near field communication (NFC) tags associated with packaged products comprises receiving, by a computing device, a production request comprising product data and one or more requested NFC processing operations, transmitting, by the computing device, the production request to middleware communicatively coupled to an NFC reader, positioning a packaged product adjacent the NFC reader, the packaged product comprising a container having a container NFC tag and a plurality of items disposed within the container, each item of the plurality of items having a respective item NFC tag, reading, by the NFC reader, the container NFC tag and the item NFC tags of the plurality of items during a reading operation, transmitting, by the middleware, identifiers associated with the container NFC tag and the item NFC tags to the computing device, determining, by the computing device, whether a quantity of the item NFC tags read during the reading operation corresponds to an expected quantity of item NFC tags associated with the product data, associating, by the computing device, the container NFC tag with one or more of the item NFC tags, and performing, by the computing device, at least one NFC processing operation selected from the group consisting of activating one or more NFC tags, deactivating one or more NFC tags, assigning production information to one or more NFC tags, associating one or more NFC tags with inventory information, associating one or more NFC tags with shipment information, and replacing defective NFC tags with substitute NFC tags.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports a process for processing NFC tags associated with packaged products, according to an example embodiment;

FIG. 2 is a diagram showing the data flow of the process for processing NFC tags associated with packaged products, according to an example embodiment;

FIG. 3 is a flow chart of a method for processing NFC tags associated with packaged products, according to an example embodiment;

FIG. 4 is a diagram depicting the environment of the process of transmitting data from tags on a packaged product to a consumer mobile device, according to an example embodiment;

FIG. 5 is a diagram depicting an NFC tag used on a consumer product, according to an example embodiment;

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed embodiments improve upon conventional NFC processing systems by permitting multiple NFC tags associated with a packaged product to be read during a single reading operation. In various embodiments, a container NFC tag and multiple item NFC tags may be read together and processed by a computing device that determines whether the quantity of tags read corresponds to expected product information. This reduces the need for separate scanning operations and manual verification procedures that are commonly associated with existing NFC workflows. The claimed embodiments also improve the ability to associate item-level tags with a corresponding container-level tag, thereby improving product tracking, inventory management, and product traceability operations.

The claimed embodiments further improve coordination between NFC reader hardware, middleware, and external computing systems. In various embodiments, production requests may be transmitted to middleware communicatively coupled to one or more NFC readers, and identifiers obtained during reading operations may be automatically processed by a computing device. The claimed embodiments also support additional NFC processing operations including tag activation, tag deactivation, assignment of production information, shipment association, inventory association, and replacement of defective tags. As a result, the claimed embodiments reduce disconnected processing steps and improve management of NFC-tagged products during manufacturing, packaging, warehouse, and distribution operations.

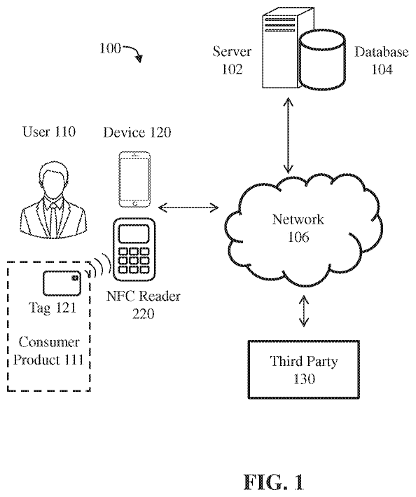

FIG. 1 is a block diagram of an operating environment 100 that supports a method and system for processing NFC tags associated with packaged products on a server communicatively coupled with a communications network 106. The server 102 and devices 120, 130 may be communicatively coupled with a communications network 106, according to an example embodiment. The environment 100 may comprise computing devices 120, 160 which may communicate with server 102 via a communications network 106. Said computing device 120 may be a mobile computing device. Mobile computing devices may comprise a cellular/mobile telephone, smart phone, tablet computer, laptop computer, handheld computer, desktop computer, wearable computer, or the like. In some embodiments, the mobile computing device includes an integrated NFC reader. In other embodiments, the mobile computing device communicates with an external NFC reader through a USB interface, Bluetooth connection, serial interface, or wireless network connection. The mobile computing device may be connected either wirelessly or in a wired or fiber optic form to the communications network 106. Communications network 106 may be a packet switched network, such as the Internet, or any local area network, wide area network, enterprise private network, cellular network, phone network, mobile communications network, or any combination of the above.

FIG. 1 also shows an NFC reader 220 configured to communicate with one or more NFC tags 121 associated with consumer products 111. NFC reader 220 may comprise a handheld NFC reader, a fixed-position NFC reader, an automated NFC reader associated with conveyor system 230, or another device configured to transmit and receive radio frequency signals for reading NFC tags. In one embodiment, NFC reader 220 comprises one or more antennas, processors, communication interfaces, and control circuitry configured to perform reading operations associated with one or more NFC tags simultaneously. NFC reader 220 may further communicate with computing device 120, server 102, middleware 210, database 104, or external system 130 through communications network 106. In one embodiment, the functionality of computing device 120 and NFC reader 220 are integrated into a single device configured to both read NFC tags and process data associated with the NFC tags.

FIG. 1 also shows an identification device or tag 121 placed on, in, or around consumer product 111. Tag 121 may be a near field communication (NFC) tag that emits radio frequency signals that comport with ISO/IEC 18092, ISO 14443, ISO 15693, NFC Forum standards, and ECMA 340 communications protocol standards. In some embodiments, tag 121 comprises a dual-technology tag configured to support both NFC communications and RFID communications. In some embodiments, the tag further supports ISO 18000-3 communications standards. The tag 121 may further comprise encryption and authentication standards including ISO/IEC 18000, ISO/IEC 29167, and ISO/IEC 20248. The tag 121 may store unique identifiers, cryptographic tokens, authentication data, production information, inventory information, shipment information, regulatory compliance information, and product traceability information associated with a consumer product.

The tag 121 may also be configured for attachment to an individual product, to a container that contains multiple products or to product packaging. In one embodiment, the tag may be attached in such a way that the tag is able to detect if the product packaging has been opened. For example, one or more conductive terminals may be disposed on the surface of the tag, and the surface of the tag may be applied (such as by adhesive) to the product packaging along a rip line or other line in which the product must be opened. When the product packaging is opened, the one or more conductive terminals are no longer conductively coupled, which may be detected by the tag. The tag 121 may comprise a flexible circuit structure, polymer substrate, laminated paper structure, ceramic substrate, or other RF-compatible material structure. In some embodiments, metallic surfaces positioned between the tag and the NFC reader may reduce reading performance, and therefore the tag may be positioned on non-metallic portions of the packaging or separated from metallic packaging structures by a spacer material. In some embodiments, the communication tag 121 further includes a printed QR code associated with the unique product identifier. The QR code may be scanned by the computing device 120 or NFC reader 220 to access the same product record and associated product information accessible through RF communication with the tag. In some embodiments, the printed QR code is uniquely associated with the corresponding NFC tag identifier stored in database 104. The QR code may be scanned independently or together with NFC scanning operations to establish associations between packaged products, containers, and grouped item tags.

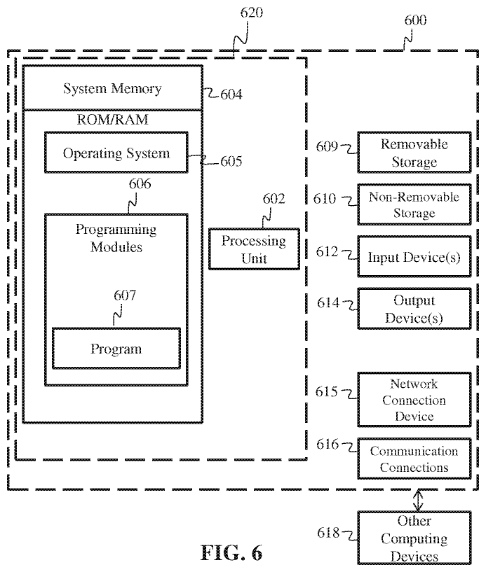

The environment 100 shows that device 120 is operated by a user 110, which may be a person, a retailer, a manufacturer, an importer, an exporter, a transporter, a government worker, a distributor, a border security worker, a tax worker, an end-user of the consumer product 111, an intermediate user of the consumer product, or the like. Server 102, tag 121 and devices 120, 130, 220 may each comprise a computing device 600, described below in greater detail with respect to FIG. 6.

The environment 100 shows that third party 130 or external system is communicatively coupled with the network 106 so as to interact with device 120, reader 220 and server 102. Third party 130 or external system may be a governmental entity, an importer, or another user system that is used to obtain information relating to consumer products, such as manufacturing information, regulatory compliance information, or tax information.

Computing device 102 includes a software engine that delivers applications, data, program code, and other information to networked devices, such as device 120. The software engine of device 102 may perform other processes such as transferring multimedia data in a stream of packets that are interpreted and rendered by a software application as the packets arrive. FIG. 1 further shows that device 102 includes a database or repository 104, which may be a relational database comprising a Structured Query Language (SQL) database stored in a SQL server. Mobile computing device 120 may also include its own database, either locally or via the cloud. The database 104 may serve related information from a product's corresponding product record (located in database 104), which may be used by devices 102, 220 and 130.

Devices 102, 120, 130, 220 and tag 121 may each include program logic comprising computer source code, scripting language code or interpreted language code that perform various functions of the disclosed embodiments. In one embodiment, the aforementioned program logic may comprise program module 606 in FIG. 6. It should be noted that although FIG. 1 shows only one mobile computing device 120, one tag 121, one NFC reader 220 and one server 102, the system of the disclosed embodiments supports any number of servers, tags, NFC readers, labels, and mobile computing devices connected via network 106. Also note that although server 102 is shown as a single and independent entity, in one embodiment, server 102 and its functionality can be realized in a centralized fashion in one computer system or in a distributed fashion wherein different elements are spread across several interconnected computer systems.

The database 104 may include a consumer product record for each individual consumer product 111. A consumer product record may include: the consumer product name, a consumer product identifier (which may be unique), a unique identifier (UID), information about the authenticity of the consumer product, consumer product packaging information, instructions for use related to the consumer product, warranty information, interactive content, information regarding integration with social networks, redirect links to the vendor or manufacturer's website, etc. A consumer product record may further include a unique product code, such as a UPC code or a QR code, corresponding to the consumer product. A consumer product record may further include a URL containing an encrypted packet that uniquely identifies said tag.

The consumer product record may further include regulatory compliance data obtained from one or more external systems, including a compliance status, one or more compliance documents, and one or more certifications issued by a governmental entity. The consumer product record may further include tax and fee data associated with the consumer product, including calculated duties, taxes, and proof of payment. In one embodiment, the consumer product record stores data received from external systems in response to one or more requests transmitted by the server, including manufacturing data, import or export data, and regulatory verification results.

In some embodiments, computing device 120 is configured to obtain product-related information from a plurality of heterogeneous external systems associated with governmental entities, manufacturers, importers, distributors, tax authorities, regulatory agencies, logistics systems, and inventory management systems. The computing device may normalize, reconcile, validate, and compare information received from the heterogeneous external systems in order to identify inconsistencies, missing information, conflicting records, tax discrepancies, compliance issues, or counterfeit indicators associated with packaged product 410.

In some embodiments, one or more machine-learning models or artificial intelligence engines are configured to analyze product traceability information, shipment history information, production records, inventory records, authentication records, and chain-of-custody information associated with packaged products. The artificial intelligence engine may generate predictive outputs, anomaly alerts, shipment-risk indicators, counterfeit-risk indicators, tax-analysis outputs, production analytics, inventory analytics, or supply-chain analytics associated with one or more packaged products.

The consumer product record may further include security data, including cryptographic tokens, hashes, or identifiers associated with the tag. In some embodiments, the database may further store user-related data associated with the consumer product, including user identification data, age verification results, and links between a user record and the consumer product record. In some embodiments, database 104 stores hierarchical relationship data linking one or more item NFC tags 416 to a container NFC tag 421 associated with a packaged product 410.

A unique identifier is a hardware-based identifier embedded within each tag during its manufacturing process. The UID is immutable and cannot be altered, serving as a secure, device-specific marker. The UID establishes a reliable link between the tag and the corresponding record in the database. When a tag is scanned using a mobile computing device, the UID is read and transmitted to a server via a communications network. The server uses the UID to access the product's record in the database. By keeping the UID permanently tied to the tag, the system ensures that only authentic tags can be used in the authentication process, further preventing counterfeit attempts.

In one embodiment, the unique identifier (UID) embedded within the tag is distinct from a unique product identifier used within the system database. The UID may serve as a hardware-based identifier that is permanently associated with the tag, while the unique product identifier may be a logical identifier used to reference the corresponding product record in the database. The UID and the unique product identifier may be linked within the database to enable secure association between the physical tag and the stored product information. In some embodiments, authentication of the consumer product is performed using the UID associated with the communication tag without requiring use of a cryptographic token. The cryptographic token may provide an additional optional layer of authentication.

The database 104 may further store production request records associated with one or more packaged products 410, including requested NFC processing operations, expected tag quantities, production dates, packaging dimensions, shipment information, and workflow status information. In some embodiments, database 104 further stores associations between container NFC tags 421 and item NFC tags 416, including grouped tag relationship data identifying which tagged items are associated with a particular container 412. Database 104 may further store scan event records including scan timestamps, scan location information, reader identifiers, antenna configuration information, operator identifiers, scan confidence values, validation results, duplicate read filtering results, failed scan records, and error notifications generated during reading operations. In some embodiments, database 104 further stores replacement history information identifying defective NFC tags and corresponding substitute NFC tags associated with packaged products 410. Database 104 may further store workflow state information associated with activation operations, deactivation operations, quality control status, shipment verification status, inventory status, and return processing status associated with one or more NFC tags.

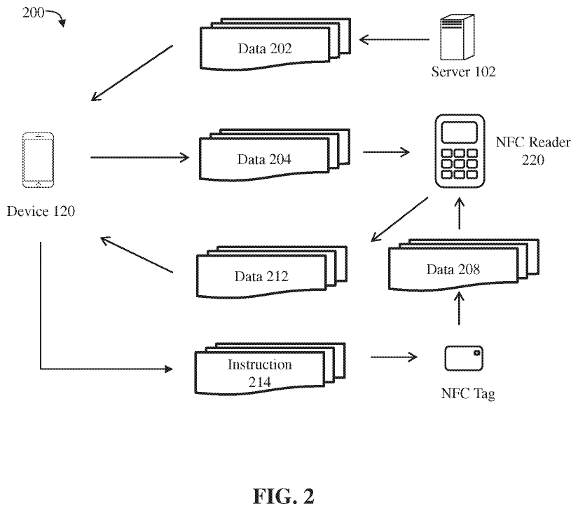

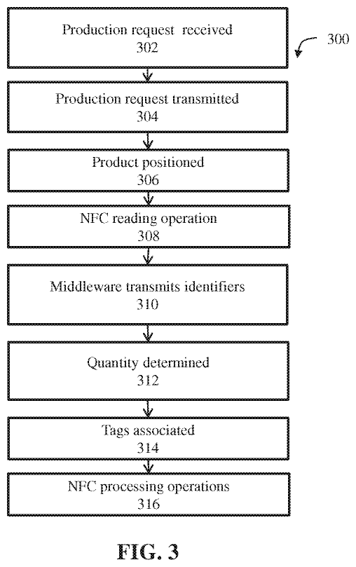

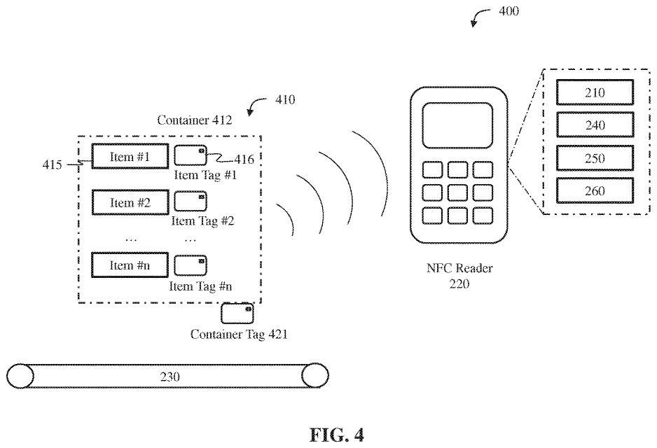

The method and system for processing NFC tags associated with packaged products is described in more detail below with reference to FIGS. 2-4. FIG. 2 illustrates data flow 200 associated with communications between computing device 120, middleware 210, NFC reader 220, database 104, and one or more NFC tags associated with packaged product 410. FIG. 3 illustrates process flow 300 for performing grouped NFC reading operations and associated NFC processing operations. FIG. 4 illustrates packaged product 410 comprising container 412 having container NFC tag 421 and a plurality of items 415 each associated with one or more item NFC tags 416.

Referring again to FIGS. 2-4, at step 302, computing device 120 may receive a production request 202 associated with one or more packaged products 410. In one embodiment, the production request comprises product data and one or more requested NFC processing operations. The production request may originate from server 102, database 104, external system 130, or another computing device communicatively coupled to communications network 106. In one embodiment, the production request is generated through a production management interface associated with a proprietary platform. The production request may comprise a unique request identifier, a production date, product dimensions, product name, quantity information, box dimensions, quantity of products expected within a container, and one or more requested processing operations. In some embodiments, the production request further specifies a quantity of packaged products to be processed, and the system may automatically terminate reading operations after the requested quantity has been processed.

In one embodiment, the requested NFC processing operations comprise one or more operations selected from activation of NFC tags, deactivation of NFC tags, associating product tags with container tags, assigning production dates to tags, associating inventory information with tags, associating shipment information with tags, and replacement of defective tags with substitute tags. In some embodiments, the production request further includes instructions relating to defective product replacement operations, including identifiers associated with defective tags and replacement tags. The production request may be formatted as a structured data file, including a JSON file, XML file, delimited file, or other machine-readable format. In one embodiment, the production request is transmitted through a file transfer protocol (FTP) system comprising one or more input and output directories associated with a production environment.

At step 304, computing device 120 transmits the production request 204 to middleware 210 communicatively coupled to NFC reader 220. Middleware 210 may comprise software configured to manage communications between computing device 120, server 102, database 104, and NFC reader 220. In one embodiment, middleware 210 receives production requests from the proprietary platform and controls operation of NFC reader 220 according to the instructions contained within the production request. Middleware 210 may further collect identifiers associated with tags read during scanning operations and generate one or more output files associated with the production request. In some embodiments, middleware 210 and NFC reader 220 are connected to a local computer system through one or more USB interfaces. As used herein, middleware 210 may comprise one or more software modules configured to facilitate communications and data processing between NFC reader 220 and one or more external computing systems.

At step 306, a packaged product 410 is positioned adjacent NFC reader 220. In one embodiment, packaged product 410 comprises a container 412 having a container NFC tag 421 and a plurality of items 415 disposed within container 412, wherein each item 415 comprises a respective item NFC tag 416. In FIG. 4, reference numeral 416 collectively represents a plurality of item NFC tags and reference numeral 415 collectively represents a plurality of items. The packaged product may comprise consumer products. The items 415 may comprise cigars, tobacco products, consumer products, pharmaceutical products, luxury goods, electronics, or other tagged products. In one embodiment, the packaged product is manually positioned adjacent a handheld NFC reader. The handheld NFC reader may comprise a housing configured in a paddle or racquet configuration that contains one or more antennas and a control board. In another embodiment, packaged product 410 is positioned on conveyor system 230 associated with an automated NFC reader. Conveyor system 230 may transport packaged products through a reading area comprising a plurality of fixed-position or vertically adjustable antennas arranged adjacent the conveyor path. In some embodiments, the antennas are positioned above, below, beside, or around the packaged products to perform grouped reading operations while the packaged products move through the reading area.

In one embodiment, automated NFC reader 220 comprises an antenna assembly 240 including a plurality of antennas positioned adjacent conveyor system 230. The antenna assembly 240 may comprise a tunnel-style or portal-style reading structure configured to surround at least a portion of packaged product 410 during the reading operation. In some embodiments, the antenna assembly comprises multiple HF antennas operating at approximately 13.56 MHz and configured to communicate using ISO 14443, ISO 15693, NFC, and related standards. In some embodiments, one or more antennas are vertically adjustable relative to conveyor system 230 to accommodate packaged products of different heights. Conveyor system 230 may further include guide rails, positioning structures, separators, and stop-position controls configured to align packaged products within the reading area. In some embodiments, automated NFC reader 220 further comprises a visual indicator 250 configured to provide a visual indication regarding whether a quantity of tags read corresponds to an expected quantity associated with the packaged product.

In some embodiments, antenna assembly 240 comprises multiple fixed-position antennas configured to perform simultaneous or sequential scanning operations from different positions adjacent packaged product 410. In some embodiments, one or more antennas are vertically repositionable relative to conveyor system 230 to accommodate packaged products having different dimensions. In some embodiments, the system performs repeated scan passes while conveyor system 230 moves the packaged product bidirectionally through the reading zone until an expected quantity of tags is detected.

In some embodiments, conveyor system 230 and antenna assembly 240 are controlled by computing device 120 or middleware 210 during the reading operation. Computing device 120 may control conveyor speed, antenna movement timing, scan duration, scan frequency, or initiation of additional scanning operations based on whether the quantity of detected tags corresponds to an expected quantity associated with packaged product 410. In some embodiments, conveyor system 230 automatically pauses movement of packaged product 410 when one or more expected tags are not detected.

In some embodiments, conveyor system 230 comprises a multi-stage conveyor assembly including an entry conveyor section, a reading-zone conveyor section, and an exit conveyor section. The conveyor system may further comprise programmable logic controller (PLC) control systems configured to coordinate conveyor movement, positioning operations, bidirectional movement operations, stop-position operations, scan timing operations, and communication with middleware 210.

At step 308, NFC reader 220 reads container NFC tag 421 and item NFC tags 416 during a reading operation. The reading operation may comprise simultaneous reading of multiple NFC tags located within or around container 412 and may comprise reading a variety of data 208 from each tag. In one embodiment, NFC reader 220 reads unique identifiers (UIDs) associated with each NFC tag. In some embodiments, the reading operation is performed while packaged product 410 remains stationary. In other embodiments, the reading operation is performed while packaged product 410 is moving along conveyor system 230. NFC reader 220 may transmit the read identifiers to middleware 210 in real time or near real time. In one embodiment, middleware 210 generates a structured data file containing identifiers associated with tags read during the reading operation and associates the identifiers with the production request identifier.

In some embodiments, middleware 210 is configured to perform one or more preprocessing operations on identifiers received from NFC reader 220 before transmitting the identifiers to computing device 120. The preprocessing operations may comprise filtering duplicate tag reads, removing incomplete reads, validating identifier formatting, timestamping read events, grouping identifiers according to a particular packaged product 410, buffering read events, retrying failed read operations, and generating error notifications. Middleware 210 may further maintain temporary local storage of read identifiers in the event of interrupted network communications with server 102 or database 104. In some embodiments, middleware 210 performs validation operations to determine whether a quantity of identifiers received during a reading operation corresponds to an expected quantity associated with the production request before transmitting the identifiers to computing device 120.

In some embodiments, middleware 210 communicates with NFC reader 220 through one or more wired or wireless communication interfaces. The communication interfaces may comprise USB, serial communication interfaces, Ethernet, Wi-Fi, Bluetooth, TCP/IP communication interfaces, or combinations thereof. In some embodiments, middleware 210 executes locally on a computer system connected directly to NFC reader 220. In other embodiments, middleware 210 executes remotely on server 102 or in a cloud computing environment communicatively coupled to NFC reader 220 through communications network 106.

In some embodiments, NFC reader 220 performs anti-collision operations during the reading operation to distinguish between multiple NFC tags located within container 412. The anti-collision operations may comprise sequential interrogation of tags, signal timing analysis, signal strength analysis, repeated scan reconciliation, duplicate read filtering, or time-window filtering. In some embodiments, middleware 210 or computing device 120 assigns confidence values to read operations based on signal quality, quantity of repeated reads, or consistency between successive scanning operations. In some embodiments, the reading operation comprises multiple scan passes performed at different antenna positions or orientations relative to packaged product 410. Identifiers obtained from multiple scan passes may be aggregated by middleware 210 or computing device 120 to determine a final set of identifiers associated with packaged product 410. In some embodiments, the system automatically initiates one or more additional scan passes if the quantity of detected tags does not correspond to an expected quantity associated with the production request. In some embodiments, NFC reader 220 dynamically adjusts transmission power, antenna tuning parameters, scan duration, scan frequency, or read-zone dimensions during the reading operation based on characteristics associated with packaged product 410. In some embodiments, NFC reader 220 simultaneously reads NFC tags associated with multiple packaged products 410 positioned within a shared reading area. Middleware 210 or computing device 120 may group the detected identifiers according to each packaged product based on signal timing, antenna position, scan sequence information, packaging identifiers, or production request data.

In some embodiments, NFC reader 220 comprises one or more FEIG CPR-series readers communicatively coupled to one or more FEIG ANT-series HF antennas configured for grouped NFC reading operations. The reader may communicate through USB, RS232, Ethernet, TCP/IP, wireless interfaces, or serial communication interfaces. In some embodiments, middleware 210 controls sequential antenna activation, multiplexing operations, repeated scan operations, duplicate-read filtering operations, and grouped tag reconciliation operations.

At step 310, middleware 210 transmits identifiers 212 associated with container NFC tag 421 and item NFC tags 416 to computing device 120. At step 312, computing device 120 determines whether the quantity of item NFC tags 416 read during the reading operation corresponds to an expected quantity associated with the product data contained in the production request. In one embodiment, the expected quantity corresponds to the number of cigars or products expected within a particular container. If the quantity of tags read does not correspond to the expected quantity, the system may generate an error notification, visual alert, log entry, or request for an additional reading operation. In some embodiments, the identifiers associated with the tags are grouped according to each packaged product that was scanned during the reading operation.

In some embodiments, identifiers associated with container NFC tag 421 and item NFC tags 416 are stored in database 104 together with production information, shipment information, inventory information, operator information, timestamp information, scan location information, and device identification information associated with NFC reader 220. The stored information may be used for authentication operations, inventory tracking, return processing, warehouse management, shipment verification, supply chain analysis, or regulatory compliance operations.

At step 314, computing device 120 associates container NFC tag 421 with one or more item NFC tags 416. In one embodiment, the association establishes a relationship between a container and the products contained within the container so that the products may later be identified as belonging to that container.

At step 316, computing device 120 performs one or more NFC processing operations. In various embodiments, the NFC processing operations comprise activating one or more NFC tags, deactivating one or more NFC tags, assigning production dates to NFC tags, associating inventory information with NFC tags, associating shipment information with NFC tags, and replacing defective NFC tags with substitute NFC tags. In some embodiments, computing device 120 performs the NFC processing operation by transmitting one or more instructions 214 to one or more NFC tags. In one embodiment, the system further comprises optical scanner 260 configured to read a barcode, QR code, serial number, or security code associated with packaged product 410. Barcode information or QR-code information obtained by optical scanner 260 may be associated with container NFC tag 421 and stored in database 104 together with corresponding item-tag identifiers. Barcode information obtained by optical scanner 260 may be associated with container NFC tag 421 and stored in database 104 together with the corresponding tag identifiers. In some embodiments, replacement operations comprise associating substitute item NFC tags with a previously scanned container NFC tag in place of defective or damaged item NFC tags.

In some embodiments, activation or deactivation of NFC tags comprises modifying one or more data values, security states, authentication states, memory locations, or operational parameters associated with the NFC tags. In some embodiments, activation operations are performed after packaged products 410 successfully pass a quality control process, while deactivation operations are performed for defective products, returned products, recalled products, or products removed from inventory.

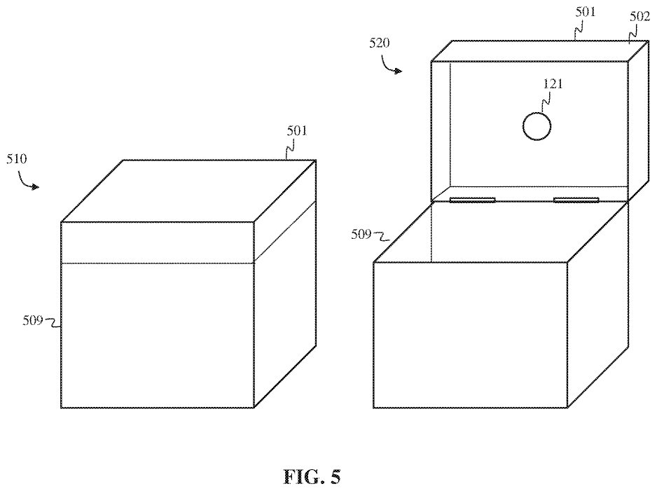

FIG. 5 diagram depicting an NFC tag 121 used on a consumer product 501, according to an example embodiment. FIG. 5 illustrates a consumer product, specifically a cigar box, which incorporates the claimed invention to authenticate the product and deter counterfeiting. The cigar box, labeled as consumer product 501, features a hinged top door 502 that opens to reveal an enclosure 509. The exterior may be adorned with brand-specific engravings, embossed detailing, or foil stamping. The cigar box 501 is shown in closed orientation 510 and open orientation 520.

A tag 121 is affixed to the interior of the top door 502 of the cigar box. This tag incorporates multiple security elements. It is constructed from durable adhesive-backed materials, such as polycarbonate or laminated security paper, designed to withstand handling while preserving its legibility. The tag may include a high-resolution printed brand logo applied using techniques like hot foil stamping or UV printing, ensuring durability and resistance to replication. The tag enables digital authentication by allowing a user to scan it with a mobile computing device. The tag facilitates electronic verification through database lookup, as described above. This increases the complexity of counterfeiting and ensures that each cigar box can be uniquely identified and authenticated at multiple points throughout the supply chain.

In some embodiments, communication tag 121 comprises a dual-technology tag configured to support both NFC communications and optical code scanning operations. The communication tag 121 may include a printed QR code, barcode, serial number, alphanumeric code, or security identifier associated with the unique identifier stored within the tag. The printed code may be scanned independently of NFC communication to retrieve the same product record associated with the tag. In some embodiments, the printed code and NFC identifier are linked together within database 104 to provide multiple authentication mechanisms for packaged product 410.

FIG. 6 is a block diagram of a system including an example computing device 600 and other computing devices. Consistent with the embodiments described herein, the aforementioned actions performed by device 102, 120, 121, 130 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for system 100 and process 300, as described above. Process 300 may operate in other environments and are not limited to computing device 600.

With reference to FIG. 6, a system consistent with an embodiment may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g., random-access memory (RAM)), non-volatile (e.g., read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of devices 102, 120, 121, 130. Furthermore, embodiments may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable, and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. Computing device 600 may also include a vibration device capable of initiating a vibration in the device on command, such as a mechanical vibrator or a vibrating alert motor. The aforementioned devices are only examples, and other devices may be added or substituted.

Computing device 600 may also contain a network connection device 615 that may allow device 600 to communicate with other computing devices 618, such as over a network in a distributed computing environment, for example, an intranet or the Internet. Device 615 may be a wired or wireless network interface controller, a network interface card, a network interface device, a network adapter, or a LAN adapter. Device 615 allows for a communication connection 616 for communicating with other computing devices 618. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g., program module 607) may perform processes including, for example, one or more of the stages of the process 300 as described above. The aforementioned processes are examples, and processing unit 602 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages, and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for processing near field communication (NFC) tags associated with packaged products, the method comprising:
a) receiving, by a computing device, a production request comprising product data and one or more requested NFC processing operations;
b) transmitting, by the computing device, the production request to middleware communicatively coupled to an NFC reader;
c) positioning a packaged product adjacent the NFC reader, the packaged product comprising a container having a container NFC tag and a plurality of items disposed within the container, each item of the plurality of items having a respective item NFC tag;
d) reading, by the NFC reader, the container NFC tag and the item NFC tags of the plurality of items during a reading operation;
e) transmitting, by the middleware, identifiers associated with the container NFC tag and the item NFC tags to the computing device;
f) determining, by the computing device, whether a quantity of the item NFC tags read during the reading operation corresponds to an expected quantity of item NFC tags associated with the product data;
g) associating, by the computing device, the container NFC tag with one or more of the item NFC tags; and
h) performing, by the computing device, at least one NFC processing operation selected from the group consisting of: activating one or more NFC tags, deactivating one or more NFC tags, assigning production information to one or more NFC tags, associating one or more NFC tags with inventory information, associating one or more NFC tags with shipment information, and replacing defective NFC tags with substitute NFC tags.

2. The method of claim 1, wherein the NFC reader comprises a handheld NFC reader configured to be manually positioned adjacent the packaged product during the reading operation.

3. The method of claim 1, wherein the NFC reader comprises an automated NFC reader associated with a conveyor system configured to transport the packaged product through a reading area.

4. The method of claim 3, wherein the automated NFC reader comprises a plurality of antennas positioned adjacent the conveyor system and configured to read the container NFC tag and the item NFC tags while the packaged product moves through a reading area.

5. The method of claim 4, wherein at least one antenna of the plurality of antennas is vertically adjustable relative to the conveyor system to accommodate packaged products having different dimensions.

6. The method of claim 1, further comprising generating, by the middleware, a data file comprising the identifiers associated with the container NFC tag and the item NFC tags read during the reading operation.

7. The method of claim 1, wherein the production request further comprises a requested quantity of packaged products to be processed, and wherein the method further comprises automatically terminating reading operations after the requested quantity of packaged products has been processed.

8. The method of claim 1, wherein the production information assigned to one or more NFC tags comprises a production date associated with the packaged product.

9. The method of claim 1, further comprising reading, by an optical scanner, a barcode or a unique QR code associated with either the packaged product or any one of the plurality of items within a container of the packaged product, and associating barcode information or QR-code information obtained from the barcode or unique QR code with said container or item NFC tag.

10. The method of claim 1, wherein the replacing defective NFC tags with substitute NFC tags comprises associating one or more substitute NFC tags with the container NFC tag in place of one or more defective NFC tags.

11. The method of claim 3, wherein the conveyor system is configured to move the packaged product bidirectionally through the reading area during repeated scan operations until an expected quantity of item NFC tags is detected.

12. A system for processing near field communication (NFC) tags associated with packaged products, the system comprising:
a) a computing device configured to receive a production request comprising product data and one or more requested NFC processing operations;
b) middleware communicatively coupled to the computing device;
c) an NFC reader communicatively coupled to the middleware and configured to read NFC tags associated with a packaged product, the packaged product comprising a container having a container NFC tag and a plurality of items disposed within the container, each item of the plurality of items having a respective item NFC tag;
d) wherein the middleware is configured to: i) receive the production request from the computing device; ii) receive identifiers associated with the container NFC tag and the item NFC tags from the NFC reader; and iii) transmit the identifiers associated with the container NFC tag and the item NFC tags to the computing device; and
e) wherein the computing device is further configured to: i) determine whether a quantity of the item NFC tags read during a reading operation corresponds to an expected quantity of item NFC tags associated with the product data; ii) associate the container NFC tag with one or more of the item NFC tags; and iii) perform at least one NFC processing operation selected from the group consisting of: activating one or more NFC tags, deactivating one or more NFC tags, assigning production information to one or more NFC tags, associating one or more NFC tags with inventory information, associating one or more NFC tags with shipment information, and replacing defective NFC tags with substitute NFC tags.

13. The system of claim 12, wherein the NFC reader comprises a handheld NFC reader configured to be manually positioned adjacent the packaged product during the reading operation.

14. The system of claim 12, wherein the NFC reader comprises an automated NFC reader associated with a conveyor system configured to transport packaged products through a reading area.

15. The system of claim 14, wherein the automated NFC reader comprises a plurality of antennas positioned adjacent the conveyor system and configured to read the container NFC tag and the item NFC tags while the packaged product moves through a reading area.

16. The system of claim 15, wherein at least one antenna of the plurality of antennas is vertically adjustable relative to the conveyor system to accommodate packaged products having different dimensions.

17. The system of claim 12, wherein the middleware is further configured to generate a data file comprising the identifiers associated with the container NFC tag and the item NFC tags read during the reading operation.

18. The system of claim 12, wherein the computing device is further configured to assign a production date to one or more NFC tags associated with the packaged product.

19. The system of claim 12, further comprising reading, by an optical scanner, a barcode or a unique QR code associated with either the packaged product or any one of the plurality of items within a container of the packaged product and associating barcode information or QR-code information obtained from the barcode or unique QR code with the container or item NFC tag.

20. A non-transitory computer readable medium storing instructions that, when executed by one or more processors, cause a computing system to perform operations for processing near field communication (NFC) tags associated with packaged products, the operations comprising:
a) receiving a production request comprising product data and one or more requested NFC processing operations;
b) transmitting the production request to middleware communicatively coupled to an NFC reader;
c) causing a packaged product to be positioned adjacent the NFC reader, the packaged product comprising a container having a container NFC tag and a plurality of items disposed within the container, each item of the plurality of items having a respective item NFC tag;
d) receiving, from the middleware, identifiers associated with the container NFC tag and the item NFC tags read by the NFC reader during a reading operation;
e) determining whether a quantity of the item NFC tags read during the reading operation corresponds to an expected quantity of item NFC tags associated with the product data;
f) associating the container NFC tag with one or more of the item NFC tags; and
g) performing at least one NFC processing operation selected from the group consisting of activating one or more NFC tags, deactivating one or more NFC tags, assigning production information to one or more NFC tags, associating one or more NFC tags with inventory information, associating one or more NFC tags with shipment information, and replacing defective NFC tags with substitute NFC tags.
